(19) United States
(12) Patent Application Publication
(10) Pub. No.: US 2026/0175884 A1
(43) Pub. Date: Jun. 25, 2026

(54) PREPLANNED LOCOMOTIVE COMMUNICATIONS LOSS MANAGEMENT

(71) Applicant: Progress Rail Locomotive Inc., LaGrange, IL (US)

(72) Inventor: Benjamin Arthur Raeder, Bartlett, IL (US)

(73) Assignee: Progress Rail Locomotive Inc., LaGrange, IL (US)

(21) Appl. No.: 18/988,069

(22) Filed: Dec. 19, 2024

(51) Int. Cl. B61L 15/00

(52) U.S. Cl. CPC B61L 15/0063; B61L 15/0018; B61L 15/009

(57) ABSTRACT

Operating one or more locomotives of a train consist when communications to the one or more locomotives are lost depriving the locomotives of receiving real-time operating commands in an autonomous or semi-autonomous operating environment is provided. An energy management system generates real-time operating commands including throttle and brake settings for the train consist locomotives for operating the locomotives when communications to the locomotives are operating. Preplanned operating commands are generated for the train consist locomotives to set throttle and brake settings for the locomotives when communications to a lead train consist locomotive or between the lead train consist locomotive and remote or trailing train consist locomotives are lost. After communications are restored, the energy management system automatically switches from the preplanned operating commands back to real-time operating commands.

### TECHNICAL FIELD

The present disclosure relates to operation of train locomotives and associated train consists. More particularly, the present disclosure relates to generation and utilization of preplanned locomotive operating commands during communications losses with train locomotives operating in associated train consists.

### BACKGROUND

Trains of varying lengths and types often include a number of locomotives necessary for providing power required for moving varying numbers of cargo and/or passenger rail cars. For trains operating autonomously or semi-autonomously, operating commands such as throttle and brake settings are generated at a remote train management system and are passed to a lead locomotive that, in turn, passes the operating commands to one or more other locomotives positioned in the train. Alternatively, the operating commands may be generated at a lead locomotive which, in turn, passes the operating commands to the one or more other locomotives positioned in the train.

At times, communications from a remote train management system to a lead locomotive or from a lead locomotive to one or more other locomotives operating in the train may be lost. For example, a physical communication system such as a cable between the lead locomotive and other locomotives operating in the train or radio communications operating between the lead locomotive and other locomotives operating the train may be damaged or may become temporarily inoperable. For another example, a lead locomotive communicating with the remote train management system and/or with other locomotives included in the train may utilize radio or wireless communications that may be temporarily lost when the train passes through a tunnel or other location where such communications are not available or reliable.

If communications between the remote train management system to the lead locomotive are lost, or if communications between the lead locomotive and the one or more other locomotives operating in the train are lost, those locomotives no longer receiving operating commands move into a “safe state” for safety purposes. Such a “safe state” temporarily involves shifting those locomotives to a reduced (or idle) throttle setting and may include application of braking. Unfortunately, such pre-defined one-size-fits-all “safe states” are not always appropriate or even safe. For example, if the train is traversing a steep incline or crossing over the apex of a hill or mountain, placing the locomotives into an idle or braking configuration may cause undesired stresses on the locomotive and/or railcar couplings or even may cause the train to break into two or more sections.

Such undesirable situations may be exacerbated owing to use of proprietary or limited communications systems between remote train management systems and lead locomotives and/or between lead locomotives and one or more other locomotives included in the train because corrective commands may be required from a proprietary remote train management system associated with the train thus preventing corrective operating commands to be sent to the lead locomotive by third-party systems such as a different rail operator or different rail management system.

An example communication system and method for a vehicle consist is described in U.S. Pat. No. 11,964,678 B2 to Schoenly, et al. titled “Communication System and Method of a Vehicle Consist” (hereafter “the '678 document”). The '678 document describes a communication system and method to receive trip data that represents one or more characteristics of an upcoming trip of the vehicle system along a route at an energy management system disposed onboard a vehicle system formed from a lead vehicle and one or more remote vehicles. This '678 patent focuses on a linking process between the lead vehicle and a modem.

Although the systems and methods of the '678 document describe establishing communications from a lead vehicle to one or more remote vehicles, the '678 document does not describe generating and utilizing preplanned operating commands for lead and remote or trailing locomotives in a train consist that may be automatically utilized in the event of a loss of communications between the lead locomotive and the remote or trailing locomotives. Moreover, the systems and methods of the '678 document do not provide for automatically switching from the preplanned operating commands back to real-time operating commands after communications from the lead locomotive and the remote or trailing locomotives is reestablished.

Examples of the present disclosure are directed to overcoming the deficiencies described above.

### SUMMARY OF THE INVENTION

Methods and systems provide for controlling operation of a train consist. One or more real-time operating commands are generated for controlling operation of a train consist locomotive. The train consist locomotive is operated according to the one or more real-time operating commands. One or more preplanned operating commands are generated for controlling operation of the train consist locomotive during a period in which the one or more real-time operating commands are not available to the train consist locomotive. An indication is received that the one or more real-time operating commands are not available to the train consist locomotive. The train consist locomotive then is operated according to the one or more preplanned operating commands.

Prior to generating one or more real-time operating commands for controlling operation of a train consist locomotive, an energy management system is populated with one or more track conditions. According to examples, the one or more track conditions may include one or more of track terrain, track curvature, track length, track signaling, track speed limits, locations of track stops, and track crossings. One or more real-time operating commands are generated for controlling operation of a train consist locomotive based on the one or more track conditions. One or more preplanned operating commands are generated for controlling operation of the train consist locomotive based on the one or more track conditions.

According to examples, generating one or more real-time operating commands for controlling operation of a train consist locomotive includes generating an initial one or more real-time operating commands for controlling operation of the train consist locomotive. The initial one or more real-time operating commands for controlling operation of the train consist locomotive are passed to a machine learning system for refining the initial one or more real-time operating commands for controlling operation of the train consist locomotive.

Generating the one or more preplanned operating commands for controlling operation of the train consist locomotive includes generating an initial one or more preplanned operating commands for controlling operation of the train consist locomotive. The initial one or more preplanned operating commands for controlling operation of the train consist locomotive are passed to a machine learning system for refining the initial one or more preplanned operating commands for controlling operation of the train consist locomotive.

According to examples a system for controlling operation of a train consist includes an energy management system operative to generate one or more real-time operating commands for controlling operation of a train consist locomotive. The energy management system is operative to generate one or more preplanned operating commands for controlling operation of the train consist locomotive during a period in which the one or more real-time operating commands are not available to the train consist locomotive. The system includes a locomotive management system operative to operate the train consist locomotive according to the one or more real-time operating commands. The energy management system is further operative to receive an indication that the one or more real-time operating commands are not available to the train consist locomotive. The locomotive management system is further operative to operate the train consist locomotive according to the one or more preplanned operating commands.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example railway system showing a distributed train consist in communication with a remote train management system, according to examples of the present disclosure.

FIG. 2 illustrates example components of a train locomotive control system, according to examples of the present disclosure.

FIG. 3 illustrates an example communication and control system for multiple locomotives assigned to a multiple locomotive train consist.

FIG. 4 illustrates an example communication and control system for multiple locomotives assigned to a multiple locomotive train consist.

FIG. 5 illustrates a flow diagram of an example method for generating, verifying, and distributing operating commands to locomotives in a distributed train consist, according to examples of the present disclosure.

FIG. 6 illustrates a flow diagram of an example method for generating and utilizing real-time and preplanned operating commands in a distributed train consist, according to examples of the present disclosure.

FIG. 7 illustrates a computer architecture diagram showing illustrative hardware architecture for implementing aspects of various technologies of the present disclosure.

### DETAILED DESCRIPTION

Wherever possible, the same reference numbers will be used throughout the figures to refer to the same or like parts. In the figures, the left-most digit(s) of a reference number identifies the figure in which the reference number first appears.

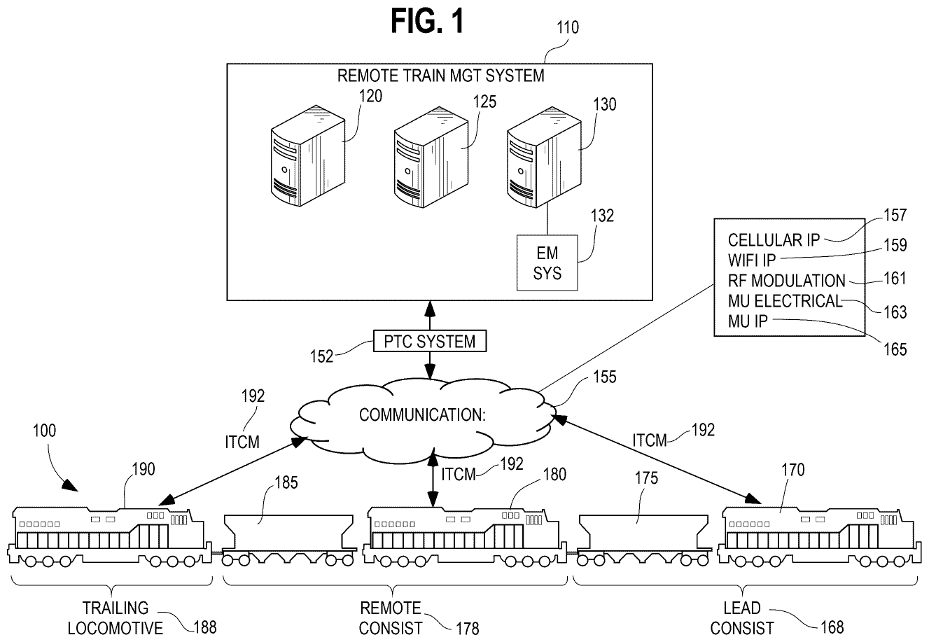

FIG. 1 illustrates an example railway system showing a distributed train consist in communication with a remote train management system, according to examples of the present disclosure. As illustrated in FIG. 1, a train consist 100 is illustrated in communication with a remote train management system 110. According to examples of the present disclosure, the train consist 100 is illustrative of a combination of locomotives 170, 180, 190 utilized in association with a number of railcars 175, 185 for transporting cargo and/or passengers from and or origination point to a destination point. According to examples, locomotives 170, 180, 190 may include a variety of different propulsion systems, for example, diesel, electric, hybrid, natural gas, and the like. The railcars 175, 185 may include conventional railcars in which loads of cargo for example, coal, stone, lumber, products of various types, and the like may be carried, or the railcars 175, 185 may be illustrative of passenger cars in which passengers are transported from an origination point to a destination point.

According to examples of the present disclosure, the remote train management system 110 is illustrative of a remote system operated by one or more railroad organizations for organizing and managing operations of various train consists. According to examples, the remote train management system 110 may include computing and data systems for managing various train consist 100 including individual components of train consists such as locomotives 170, 180, 190, railcars 175, 185, as well as, rail systems such as track systems, switching systems, signaling systems, and the like. The remote train management system 110 may be operated by a single rail carrier at which data for its railway cars, locomotives and rail systems may be stored, or the remote train management system 110 may be illustrative of a central data management system where train operating systems and data for numerous rail carriers may be stored and managed.

The remote train management system may include one or more computing and data systems 120, 125, 130 with which operations of train consist 100 may be analyzed, generated, and distributed. According to examples, the computing and data system 120 may be utilized for building and deploying various train consist 100 for a given rail carrier or operator. For example, the computing and data system 120 may store data showing availability of railcars 175, 185, availability of locomotives 170, 180, 190 that may be utilized for building a given train consist 100 for carrying cargo and/or passengers from an origination point to a destination point as desired. In addition, the computing and data system 120 may include cargo scheduling information including cargo types, cargo origination points, cargo destination points, loading/unloading timing requirements, etc.

Referring still to FIG. 1, according to examples, the computing and data system 125 may include a variety of operational data for one or more railway systems including track and route information such as track elevation changes, track curvatures, track stopping points, track crossings, track signaling data, track speed limits, and the like. According to examples, such information for one or more railway systems may be utilized by the remote train management system 110 for assisting in the building of one or more train consist 100 according to requirements of an associated rail carrier. For example, if a given rail carrier requires a train consist 100 comprised of 75 cargo railcars and five locomotives for moving the 75 railcars cargo railcars from an origination point to a destination point, then data and computing resources from the computing and data system 120 may be utilized in concert with computing and data resources from the computing and data system 125 for determining availability of locomotives and cargo railcars and for determining various track conditions between the desired origination point and the desired destination point for ultimately determining the makeup of the desired train consist 100.

Referring still to FIG. 1, the computing and data system 130 may be illustrative of a remote system for generating train consist operating commands. According to one example, the computing and data system 130 may include a remote energy management system 132 that may be utilized for developing real-time and preplanned operating commands for the locomotives 170, 180, 190 included in the desired train consist 100. Such real-time and preplanned operating commands may include throttle settings and brake settings that will be utilized by the desired consist 100 as it travels from an origination point to a destination point. For example, as the desired train consist 100 travels from the origination point to the destination point, the remote energy management system 132 may develop throttle settings and braking settings that will be utilized by one or more locomotives contained in or included in the desired train consist 100 as the desired train consist 100 passes through different track conditions such as inclines, declines, curves, stopping points, train crossings, and the like. As understood by those skilled in the art, such energy management systems may utilize such data to improve fuel efficiency, train handling, and emissions. Fuel efficiency may be increased by automating throttling and braking considering the trains weight, track conditions and/or other conditions that may require changes in real-time operating commands passed to a lead locomotive 170 and then two other locomotives 180, 190 included in the train consists 100. As will be described below, instead of the remote energy management system 132, operating commands (real-time and preplanned) may be generated and utilized via energy management systems operating on the locomotives 170, 180, 190.

According to examples of the present disclosure, such real-time operating commands may be constantly updated, for example, every two to five seconds, according to track conditions the train consist 100 is approaching. For example, if the train consist 100 is operating in a relatively flat area, track conditions information may be utilized by the remote energy management system 132 to determine that throttle settings for each of the locomotives contained in the desired train consist 100 may be set at a given notch setting for the next 10 miles of track. However, if after the next 10 miles of track, the track encounters a steep incline, then information identifying the down range steep incline may be utilized by the remote energy management system 132 operated via the computing and data system 130 to send updated operating commands to the locomotives 170, 180, 190 to account for the coming steep incline. For example, throttle notch settings may be increased from current notch settings to higher notch settings to provide additional power from the locomotives 170, 180, 194 traversing the steep incline. If track conditions data from the computing and data system 125 indicates that after the train consist 100 moves beyond the coming steep incline that the train consist will pass down a steep decline, then the remote energy management system 132 operating via the computing data system 130 may generate real-time operating commands that will direct the locomotives 170, 180, 190 included in the train consist 100 to move to lower throttle notch settings or may direct braking to be applied by the locomotives 170, 180, 190 in order to reduce speed of the train consist 100 as it passes down the coming steep decline. That is, based on the track conditions over which the train consist 100 will pass, the remote energy management system 132 operated via the computing and data system 130 may be modify real-time operating commands in a continuous manner to provide for a safe and efficient operation of the train consist 100 from the origination point to the destination point.

According to examples of the present disclosure, and as will be described in further detail below, to account for potential communications losses between the remote train management system 110 and the locomotives of the train consist 100, or to account for communications losses from the lead locomotive 170 and one or more other locomotives 180, 190 included in the train consist 100, the remote energy management system 132 operated via the computing and data system 130 may generate preplanned operating commands for the locomotives included in the train consist 100 that will take over operation of the locomotives during the time of communications losses. According to examples, the preplanned operating commands are generated by the remote energy management system 132 based on anticipated track information received from the computing and data system 125, as described above.

According to examples, the real-time operating commands that will be generated for normal operation of the train consist 100 and the preplanned operating commands that will be generated for instances of the above-mentioned communications losses may be generated simultaneously on a continuous or semi-continuous basis (e.g., every two to five seconds). According to examples, a given train consist 100 will operate according to the real-time operating commands during normal operations, but if communications are lost with the locomotives 170, 180, 190 of the train consist 100, then the preplanned operating commands may be automatically engaged by each of the locomotives 170, 180, 190 for operating the train consist 100 in a safe manner during the time in which communications between the remote train management system 110 and locomotives 170, 180, 190 of the train consist 100 are lost or during a time in which communications from the lead locomotive 170 and other locomotives 180, 190 included in the train consist 100 are lost.

For example, if track conditions for the train consist 100 indicate that two miles ahead of the present location of the train consist 100 a steep incline will be encountered, in addition to generating real-time operating commands for the train consist 100, preplanned operating commands may be generated for the train consist 100 that will allow the train consist 100 to operate autonomously or semi-autonomously in the event that communications with the locomotives 170, 180, 190 of the train consist 100 are lost when the train consist 100 encounters the anticipated steep incline. For example, if just before the train consist 100 encounters the anticipated steep incline communications with the locomotives 170, 180, 190 are lost from the remote train management system 110 or communications from the lead locomotive 170 to the other locomotives 180, 190 included in the train consist 100 are lost, then the preplanned operating commands will be automatically engaged in place of real-time operating commands to direct the throttle and brake settings of the locomotives 170, 180, 190 during the time in which communications are lost. According to examples, as soon as communications with the locomotives 170, 180, 190 are reestablished, then real-time operating commands may be automatically generated by the remote energy management system 132 operating via the computing and data system 130 and may be passed to the locomotives 170, 180, 190 in place of the preplanned operating commands that were utilized during the period in which communications were lost.

According to examples, the preplanned operating commands for each locomotive 170, 180, 190 included in a given train consist 100 may be different. For example, if a train consist 100 loses communications as it is passing over a steep incline, the preplanned operating commands (e.g., throttle settings and brake settings) for each locomotive 170, 180, 190 may be generated on an individual basis as required based on track conditions encountered by the train consist 100. For example, based on track conditions, if the train consist 100 will be passing over the apex of a hill or mountain where the lead locomotive 170 will be on the other side of the apex while the remote locomotive 180 will be at the top of the apex and the trailing locomotive 190 will still be traveling up the incline toward the apex, then preplanned operating commands for each locomotive 170, 180, 190 may be different in order to maintain operation of the train consist 100 up the incline, over the apex of the hill or mountain and down the decline on the other side of the apex of the hill or mountain. For example, the throttle setting of the lead locomotive 170 may be set to throttle notch three, the throttle notch setting for the remote locomotive 180 may be set at throttle notch five, and the throttle notch setting for the trailing locomotive 190 may be set at throttle notch eight for assisting in moving the train consist 100 up the steep incline and over the apex of the hill or mountain while simultaneously slowing movement of the lead locomotive 170 that has passed over at the apex of the hill or mountain according to this example. As described above, after communications have been reestablished, the remote energy management system 132 operating via the computing and data system 130 may automatically generate and pass to the locomotives 170, 180, 190 real-time operating commands that may be engaged in place of the preplanned operating commands that were utilized during the period in which communications were lost.

As mentioned above, the energy management system 132 operated via the computing and data system 130 may operate as a standalone system in the remote train management system 110 for generating real-time operating commands and preplanned operating commands for use by the locomotives 170, 180, 190 of the example train consist 100, as described herein. Alternatively, the energy management system may be operated on board each of the locomotives 170, 180, 190. According to this example, instead of having real-time operating commands and preplanned operating commands generated at the remote train management system 110, the real-time operating commands and preplanned operating commands generated for locomotives 170, 180, 190 of the train consist 100 may be generated at an energy management system operated at the lead locomotive 170 or at each of the remote locomotives 180, 190. Real-time operating commands and preplanned operating commands generated at the lead locomotive 170 may be passed from the lead locomotive 170 to the remote locomotive 180 and to the trailing locomotive 190. That is, the real-time operating commands and preplanned operating commands described herein may be generated on board the lead locomotive 170 and may be passed to other locomotives 180, 190 included in the train consist 100, or real-time operating commands and preplanned operating commands for each of the locomotives 170, 180, 190 included in the train consist 100 maybe generated and utilized independently of each of the other locomotives 170, 180, 190 based on track conditions data and associated information received via the PTC system 152 from the remote train management system 110.

Referring still to FIG. 1, the positive train control (PTC) system 152 is a system that assists in preventing train collisions by automating control of train speeds based on train conditions. The PTC system 152 is a safety system that uses global positioning systems (GPS), wireless radio and other technologies to prevent train accidents. For example, the PTC system 152 may use GPS to determine translocation speeds and directions of the train consist 100. The PTC system 152 may send visual and audible information to train crews including when to slow down or stop to prevent train collisions. If a given locomotive, for example, the lead locomotive 170 does not respond to a PTC system 152 warning, the system may automatically activate brakes or may automatically reduce locomotive throttle settings and/or apply braking to slow or stop the train consist 100. In addition, the PTC system 152 may prevent unauthorized movement of the train consist 100 when entering a work zone or moving through switches that are in an incorrect position.

According to examples of the present disclosure, the PTC system 152 may communicate locations of the train consist 100, track conditions, track terrains, track signaling, and the like to the remote energy management system 132 operating via the computing and data system 130 to the energy management system operating on board locomotives 170, 180, 190 on a periodic basis (e.g., every few seconds) to enable the energy management system 132 operating at the remote train management system 110 or operating at individual locomotives 170, 180, 190 to effect changes in the real-time operating commands and/or preplanned operating commands utilized by the locomotives of the train consist 100 during normal operating conditions and during communications loss conditions.

According to examples, the communications network 155 may include a variety of communication systems, for example, cellular Internet protocol-based systems 157, Wi-Fi Internet protocol-based systems 159, radio frequency modulation systems 161, multiple unit electrical systems 163, multiple unit Internet protocol-based systems 165, and the like for passing communications from the remote train management systems system 110 and/or the PTC system 152 two the locomotives 170, 180, 190 of the train consist 100.

Referring still to FIG. 1, the interoperable train control messaging (ITCM) gateway 192 is a standardized messaging system utilized in railroad systems to enable communications between different railroad systems and back offices. According to examples of the present disclosure, the ITCM gateway 192 allows communications exchanges of information from the remote train management system 110 or from other remote systems to the locomotives 170, 180, 190 of the example train consist 100 regardless of the physical locations of locomotives 170, 180, 190 and/or regardless of communication types. According to examples, use of ITCM standardized messaging facilitates use of the PTC system 152 for passing data from remote systems to locomotives 170, 180, 190 across multiple railroad networks as may be the case with disparate rail carriers. According to one example, the ITCM gateway 192 acts as a bridge for data exchange between remote systems and locomotives 170, 180, 190 and among different rail carrier systems to ensure smooth operation and interoperability between various rail carriers.

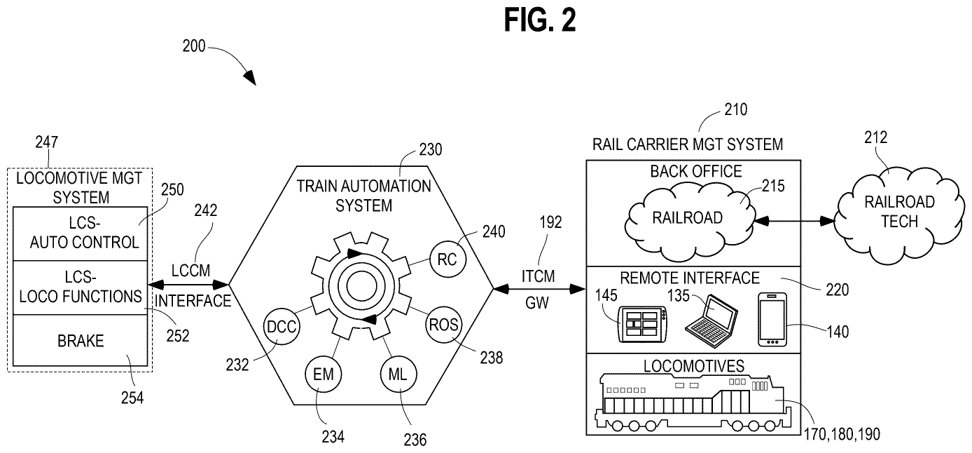

FIG. 2 illustrates example components of a train locomotive control system, according to examples of the present disclosure. In FIG. 2, some of the components of an individual locomotive 170, 180, 190 for generation and utilization of real-time and preplanned operating commands are illustrated in association with a rail carrier management system 210 associated with a given rail carrier. The rail carrier management system 210 is illustrative of systems that may be operated by a given rail carrier for its train consists 100. According to examples, the rail carrier management system 210 may be operated at the remote train management system 110, illustrated in FIG. 1, or it may be operated separately from the remote train management system 110 for a given rail carrier. For example, a given rail carrier may operate its own (e.g., proprietary) systems for developing real-time and preplanned operating commands that may receive track conditions data via the PTC system 152 or from computing and data systems 120, 125 of the remote train management system 110 for generating and utilizing real-time and preplanned operating commands as described above.

According to examples, the rail carrier management system 210 may include a back-office system 215 at which management decisions for the rail carrier such as train consist composition and train consist scheduling are performed. A railroad technology system 212 may be illustrative of a rail carrier or third-party technical development organization or system that provides technical support and engineering support to the back-office system 215. The remote interfaces 220 including devices 135, 140, 145 are illustrative of computing systems with which train consist 100 composition, train consist scheduling, real-time and preplanned operating commands are communicated to locomotives 170, 180, 190 operated by the rail carrier.

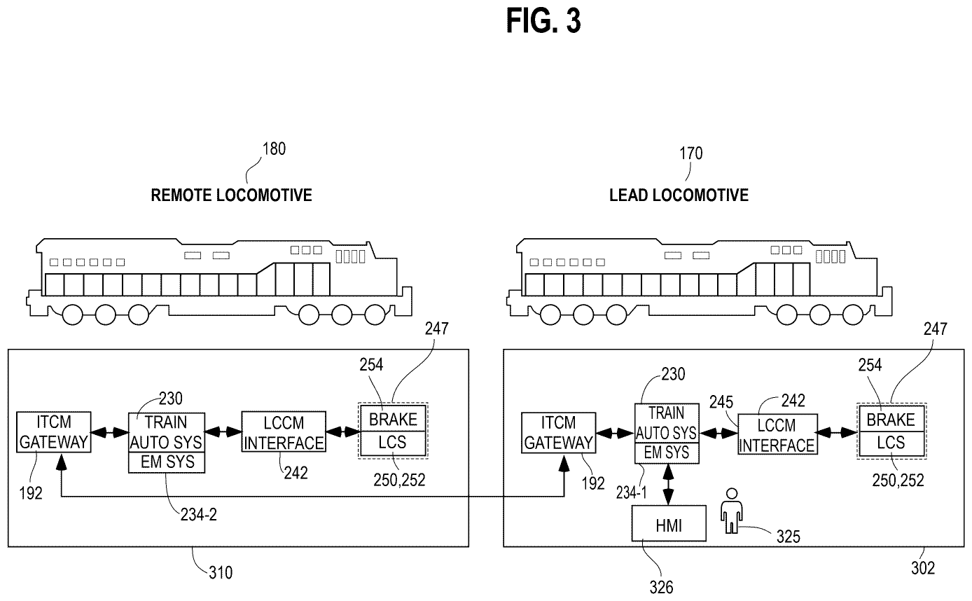

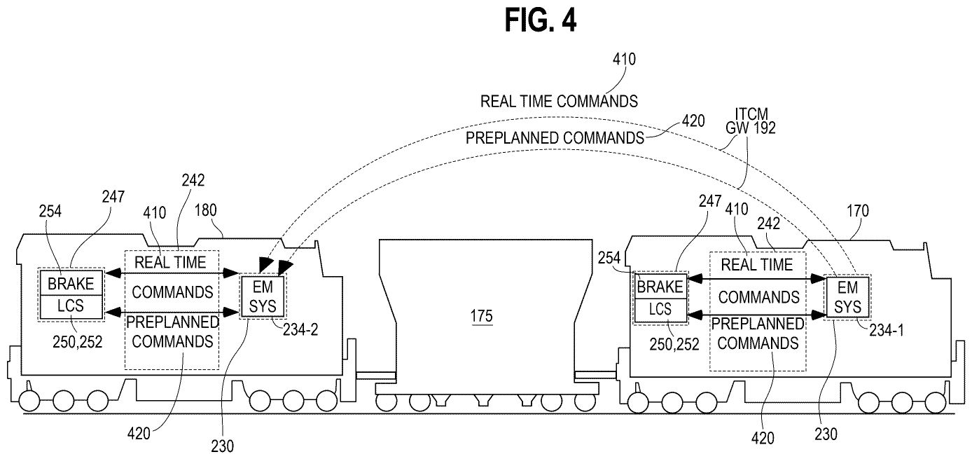

The train automation system 230 is illustrative of the system that may be operated remotely at the rail carrier management system 210 for developing and utilizing commands and systems for operating the train consist 100 autonomously or semi-autonomously. According to one example, the train automation system 230 may be operated for the rail carrier at the remote train management system 110 described above with reference to FIG. 1. Alternatively, the train automation system 230 may be operated at the rail carrier management system 210. According to another alternative, the train automation system 230 may be operated on board locomotives 170, 180, 190 as illustrated below with reference to FIGS. 3 and 4 and may be operated independently of the remote train management system 110 or independently of the rail carrier management system 210. According to examples, communications from the rail carrier management system 210 may be passed to the train automation system 230 via the ITCM gateway 192.

Referring still to the train automation system 230, the distributed consist control (DCC) system 232 is illustrative of a computing system operated within the train automation system 230 for managing distributed control of real-time and preplanned operating commands between various locomotives 170, 180, 190 in association with the remote energy management system 132 and/or the energy management system 234. According to examples of the present disclosure, the remote energy management system 132 and the energy management system 234 in addition to managing efficient energy utilization of a given locomotive 170, 180, 190 are responsible for generating real-time and preplanned operating commands for locomotives 170, 180, 190 based on track information and train consists scheduling information received via the PTC system 152 from the remote train management system 110 or the rail carrier management system 210.

According to examples, the remote energy management system 132 and the energy management system 234 may work in concert with a machine learning system 236 for generating real-time and preplanned operating commands for use by the locomotives 170, 180, 190. As understood by those skilled in the art, a machine learning system 236 uses algorithms to analyze large amounts of data by identifying patterns and learning from the analyzed data and identified patterns. Thus, the machine learning system 236 allows for improving the real-time and preplanned operating commands by comparing, verifying and modifying initially generated real-time and preplanned operating commands based on analyzed data and identify patterns. For example, if an initial real-time operating command set generated by the energy management system 234 calls for use of a throttle notch setting of notch six under certain track conditions, the machine learning system 236 may be queried for corresponding information related to the known track conditions. For example, based on vast amounts of operating commands utilized in different track conditions, the machine learning system 236 may determine that based on data analysis and pattern identification that a throttle notch of seven should be utilized instead of notch six initially generated by the energy management system 234 thus, the operating command for the this example locomotive operation may be compared with information analyzed and identified by the machine learning system 236 for improving the operating command initially generated by the remote energy management system 132 or the energy management system 234.

According to examples, the rail operating system (ROS) 238 utilizes the real-time and preplanned operating commands generated by the remote energy management system 132 or the energy management system 234 and improved by use of the machine learning system 236 for management of throttle and braking settings applied to one or more locomotives 170, 180, 190 which allows for autonomous or semi-autonomous train consist operation based on real-time data analysis. The remote control (RC) system 240 is illustrative of a system that offers remote control and telematics technologies for a train consist 100. Use of remote-control systems 240 allows for optimization of driving strategies (including throttle and braking settings) which can improve fuel and time efficiency, reduce emissions, and increase railway network capacity.

Referring still to FIG. 2, the locomotive management system 247 is illustrative of one or more control systems operating on the locomotives 170, 180, 190 to execute the real-time and preplanned operating commands passed to the locomotive 170, 180, 190, as described herein. According to examples, the locomotive control system 250 (LCS) is a locomotive system that automatically manages locomotive speed and movement based on track conditions and signals. According to one example, an automatic train control function may be utilized by the LCS auto control which monitors throttling and braking to prevent a locomotive from exceeding designated speed limits or approaching stops or crosses at excessive speeds. In some situations, the LCS auto control can take over control of functions from a human operator to ensure safety adherence and railroad rules by automatically adjusting train speeds based on track signals and speed limits and applying throwing and braking where necessary to maintain a safe and efficient operation of the train. According to examples of the present disclosure, the LCS auto control is operative to operate the locomotives 170, 180, 190 based on received real-time or preplanned operating commands.

The locomotive control system (LCS) locomotive functions may include electrical control systems responsible for managing various functions such as throttling, braking, and monitoring vital parameters of the locomotive propulsion systems. The braking system 254 is illustrative of braking systems that may be utilized by the locomotive management system 247 for applying braking to a locomotive 170, 180, 190. According to examples, the braking system 254 may include any suitable braking system available to a locomotive 170, 180, 190, including but not limited to electronic air brakes (EAB), electronically controlled pneumatic brake (ECP), dynamic braking, etc.

According to examples, communications from the train automation system 230 and its associated components to the locomotive management system 247 may be accomplished utilizing a locomotive command and control messaging (LCCM) interface 242. As understood by those skilled in the art, LCCM may serve as a messaging protocol and/or formatting to pass control messages from the train automation system 230 (including the energy management system) to the locomotive control and braking functions of the locomotive management system 247.

FIG. 3 illustrates an example communication and control system for multiple locomotives assigned to a multiple locomotive train consist. In FIG. 3, control and communications systems available to locomotives for receiving, processing and communicating real-time and preplanned operating commands for locomotives are illustrated. As described above with reference to FIG. 1, according to examples, the lead locomotive 170 may receive real-time and preplanned operating commands from the remote train management system 110 (FIG. 1) or from a dedicated rail carrier management system 210. Alternatively, the real-time and preplanned operating commands may be generated on board locomotives 170, 180, 190.

Referring still to FIG. 3, according to one example, real-time and preplanned operating commands are received at the energy management system 234-1 of the lead locomotive 170 for distribution to other locomotives 180, 190 in the train consist 100. Alternatively, track information data is received at the energy management system 234-1 of the lead locomotive 170, and the energy management system 234-1 of the lead locomotive 170 generates both real-time and preplanned operating commands for the lead locomotive 170 and for each additional locomotive 180, 190 in the train consist 100. As described above with reference to FIG. 2, the energy management system 234-1 generates the real-time and preplanned operating commands in concert with components (e.g., the machine learning system 236) of the train automation system 230.

At the lead locomotive 170, the energy management system 234-1 may send the real-time and preplanned operating commands (e.g., throttle and brake settings) via the LCCM interface 242 to the locomotive management system 247. At the locomotive management system 247, the real-time operating commands are executed as required. For example, throttle settings may be executed by the locomotive control systems 250, 252, and braking settings may be executed by the braking system 254. According to one example, the real-time and preplanned operating commands may be parsed by the energy management system 234-1 and may be sent to the train management system 247 one operating command of the time. According to this example, the preplanned operating commands are not executed by the train management system 247 unless a communications loss to the lead locomotive 170 is experienced.

If necessary, a human train engineer 325 may make manual changes to the real-time and preplanned operating commands via a human machine interface 326 (e.g., a computer, smart phone, tablet, etc.). Such human interaction may be utilized when the train consist 100 is operated in a semi-autonomous manner.

Referring still to FIG. 3, real-time and preplanned operating commands from the lead locomotive energy management system 234-1 are passed to the remote locomotive 180 (and to any additional locomotives included in the train consist 100) via the ITCM gateway 192. At the remote locomotive 180, the real-time and preplanned operating commands are passed to the energy management system 234-2 and then via the LCCM interface 242 to the train management system 247 of the remote locomotive 180 for execution of the real-time and preplanned operating commands, as required.

According to an alternative example, instead of passing the real-time and preplanned operating commands to the energy management system 234-2 of the remote locomotive 180, track information may be passed from the remote train management system 110, the rail carrier management system 210 or from the energy management system 234-1 of the lead locomotive 170. At the energy management system 234-2 of the remote locomotive 180, the real-time and preplanned operating commands may be generated. Real-time and preplanned operating commands either received at or generated by the energy management system 234-2 of the remote locomotive 180 may then be passed to the train management system 247 of the remote locomotive 180 for execution. In the event of a communications loss from the lead locomotive 170 to the remote locomotive 180, the train management system 247-2 of the remote locomotive 180 will execute preplanned operating commands until communications with the lead locomotive 170 are reestablished.

FIG. 4 illustrates an example communication and control system for multiple locomotives assigned to a multiple locomotive train consist. As illustrated in FIG. 4, as real-time operating commands 410 are received or generated at the lead locomotive energy management system 234-1, the real-time operating commands 410 are passed via the ITCM gateway 192 to the energy management system 234-2 of the remote locomotive 180. Simultaneously, the real-time operating commands 410 are passed from the lead locomotive energy management system 234-1 to the train management system 247 of the lead locomotive 170 for execution by the lead locomotive control systems 250, 252 and by the lead locomotive braking system 254. At the remote locomotive 180, the real-time operating commands received at the remote locomotive energy management system 234-2 are passed to remote locomotive train management system 247 for execution by the remote locomotive control systems 250, 252 and by the remote locomotive braking system 254. If a loss of communications occurs from the lead locomotive 170 to the remote locomotive 180, then the preplanned operating commands 420 are passed from the energy management system 234-1 of the lead locomotive 170 to the energy management system 234-2 of the remote locomotive 180. At each of the lead locomotive 170 and the remote locomotive 180, the received or generated preplanned operating commands are passed to the respective train management systems 247 of the lead locomotive 170 and remote locomotive 180 for execution, as described herein.

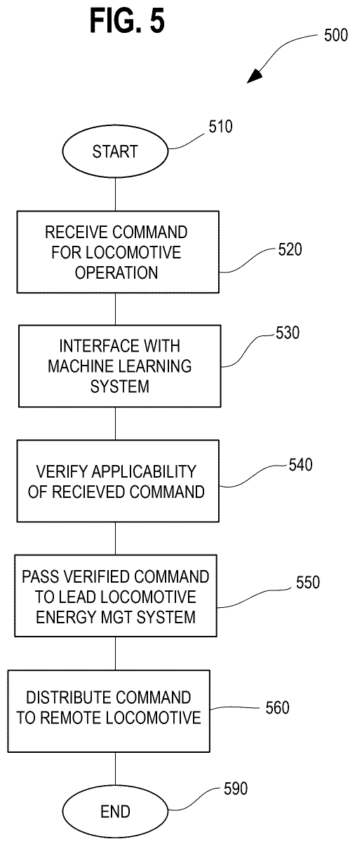

FIG. 5 illustrates a flow diagram of an example method for generating, verifying and distributing operating commands to locomotives in a distributed train consist, according to examples of the present disclosure. As described herein, according to examples, real-time and preplanned operating commands are generated for locomotives 170, 180, 190 by an energy management system 132 operating via the computing and data system 130 of the remote train management system 110, or via a train automation system 230 operated via a rail carrier management system 210, or alternatively, the real-time and preplanned operating commands may be generated at an energy management system 234-1 at lead locomotive 170, or at the energy management system 234-2 operated at one or more remote or trailing locomotives 180, 190. In such cases, the real-time and preplanned operating commands are generated by supplying track information, for example, track terrain, track curvature, track length, track signaling, track speed limits, locations of track stops, track crossings, and the like to the energy management systems 132, 234, 234-1, 234-2 operating remotely or on board locomotives 170, 180, 190. As described above, the real-time and preplanned operating commands are refined by the energy management systems in association with the machine learning system 236.

Referring now to FIG. 5, the method 500 begins at start operation 510 and proceeds to operation 520 where a command is received for locomotive operation. For example, a command received for locomotive operation may be a command to commence movement of a locomotive of the train consist 100 which requires movement of included locomotives 170, 180, 190. In response to receiving the command for locomotive operation, the method proceeds to operation 530 When the command for locomotive operation is received, the energy management system 132, 234, 234-1, 234-2 interfaces with the machine learning system 236 to generate real-time and preplanned operating commands for the locomotives operating in the example train consist 100.

In operation 540, the generated real-time and preplanned operating commands are verified and refined by the energy management system 132, 234, 234-1, 234-2 via the machine learning system 236. That is, initially generated real-time and preplanned operating commands associated with the command received at operation 520 is used to query the machine learning system 236 to verify the initially generated real-time and preplanned operating commands are optimum command. If the machine learning system 236 can improve the generated real-time and preplanned operating commands based on the learnings of the machine learning system 236, then the generated real-time and preplanned operating commands are refined accordingly.

At operation 550, the verified and refined real-time and preplanned operating commands are passed to the energy management system 234-1 of the lead locomotive 170 via the ITCM gateway 192. At operation 560, the real-time and preplanned commands received at the energy management system 234-1 of the lead locomotive 170 are distributed to the energy management systems 234-2 of the remote locomotives 180, 190 via the ITCM gateway 192 for execution, as described above with reference to FIGS. 3 and 4. The method 500 ends at operation 590.

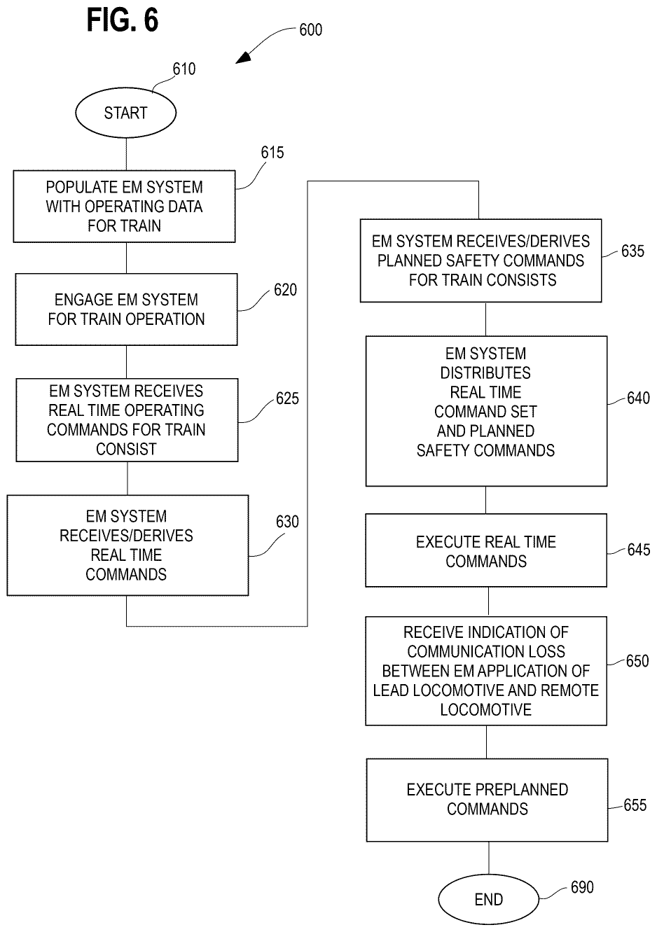

FIG. 6 illustrates a flow diagram of an example method for generating and utilizing real-time and preplanned operating commands in a distributed train consist, according to examples of the present disclosure. As described herein, the locomotives 170, 180, 190 of the train consist 100 operate according to real-time commands generated by the energy management systems 132, 234, 234-1, 234-2 of the remote train management system 110 or the real carrier management system 210, or on board at the locomotives 170, 180, 190 in association with the train automation system 230. Under normal operating conditions when communications are maintained with the lead locomotive 170 and between the lead locomotive 170 and the remote and trailing locomotives 180, 190, the real-time operating commands 410 are utilized for controlling operation of the locomotives 170, 180, 190 of the associated train consist 100. However, when communications are lost to the lead locomotive 170 or to the remote or trailing locomotives 180, 190, the preplanned operating commands 420 are utilized for controlling operation of the locomotives.

As described above with reference to FIG. 1, the real-time operating commands are updated on a periodic basis (for example, every two to five seconds) to account for ever-changing track conditions, for example, changes in track elevation, curvature, signaling, speed limits, and the like. As long as communications to the lead locomotive 170 and from the lead locomotive 170 to the remote and trailing locomotives 180, 190 are maintained, the locomotives 170, 180, 190 will operate according to the real-time operating commands. Because communications to the lead locomotive 170 or from the lead locomotive 172 the remote control locomotives 180, 190 may be lost temporarily, preplanned operating commands are generated for the locomotives 170, 180, 190 to account for down range track conditions that may be encountered during a time when communications to the lead locomotive 170 or from the lead locomotive 170 to remote or trailing locomotives 180, 190 are lost. During such communications losses, the energy management system 234-1 of the lead locomotive and 234-2 of the remote and trailing locomotives 180, 190 will execute the preplanned operating commands to maintain operation of the train consist 100 in a safe manner. For example, if the train consist 100 is approaching a steep incline, and communications to the lead locomotive 170 or from the lead locomotive 170 to the remote and/or trailing locomotives 180, 190 are lost, the preplanned operating commands generated for the locomotives 170, 180, 190 for the approaching steep incline will be engaged to operate the train consist 100 on the steep incline in a controlled and safe manner.

Referring still to FIG. 6, the method 600 begins at operation 610 and proceeds to operation 615 where the energy management system 132 of the remote train management system 110 or the EM system 234 of the train automation system 230 operated by the rail carrier management system 210 or the energy management systems 234-1 and 234-2 of the locomotives 170, 180, 190 are populated with operating data for the train including track information, for example, track terrain, track curvature, track length, track signaling, track speed limits, locations of track stops, track crossings, and the like. At operation 620, energy management systems 132, 234, 234-1, 234-2 are engaged for generating real-time operating commands and preplanned operating commands for the locomotives 170, 180, 190.

At operation 625, the energy management systems 234-1 and 234-2 of the lead locomotive 170 and for the remote and/or trailing locomotives 180, 190, respectively, receive or generate real-time operating commands for the train consist 100. At operation 630, the energy management systems 132, 234, 234-1, 234-2 generate refined real-time operating commands in association with the machine learning system 236 for the locomotives 170, 180, 190. Operation 635, the energy management systems 132, 234, 234-1, 234-2 generate preplanned operating commands in association with the machine learning system 236 for the locomotives 170, 180, 190 for use in the event of communication losses to the lead locomotive 170 or from the lead locomotive 170 to the remote and trailing locomotives 180, 190.

At operation 640, the energy management system of the lead locomotive 170 distributes the real-time and preplanned operating commands to the energy management systems 234-2 of the remote and trailing locomotives 180, 190. In addition to distributing the real-time and preplanned operating commands to the energy management systems 234-2 of the remote and trailing locomotives 180, 190, the real-time and preplanned operating commands are likewise distributed to the locomotive management systems 247 of each of the lead locomotive 170 and the remote and trailing locomotives 180, 190.

At operation 645, the real-time operating commands are executed by locomotive management systems 247 for each of the lead, remote and trailing locomotives 170, 180, 190 as described herein. At operation 650, an indication is received at the lead locomotive 170 that communications to the lead locomotive 170 or from the lead locomotive 170 to the remote and/or trailing locomotives 180, 190 has been lost. For example, the train consist 100 may be travelling through a tunnel or other location with unreliable communications.

At operation 655, in response to the indicated communications loss, the energy management system 234-1 of the locomotive 170 and energy management systems 234-2 of the remote and/or trailing locomotives 180, 190 automatically execute the preplanned operating commands to operate the locomotives 170, 180, 190 of the train consist 100 during the period of the communications loss. According to examples, prior to operating the train consist including the locomotives 170, 180, 190 according to the preplanned operating commands, operation of the train consist according to the real-time operating commands is terminated. When communications are restored to the lead locomotive 170, or between the lead locomotive 170 and the remote and/or trailing locomotives 180, 190, the energy management systems 234-1 of the lead locomotive 170 and the energy management systems 234-2 of the remote and trailing locomotives 190 automatically terminate operation according to the preplanned operating commands and switch back to the real-time operating commands to operation according to the real-time operating commands generated for the locomotives 170, 180, 190. As should be appreciated, during the period of communications loss, updated real-time operating commands may have been generated that will be executed after communications are reestablished. If the period of the communications loss is minimal, then the real-time operating commands in use before the communications loss may be automatically re-engaged.

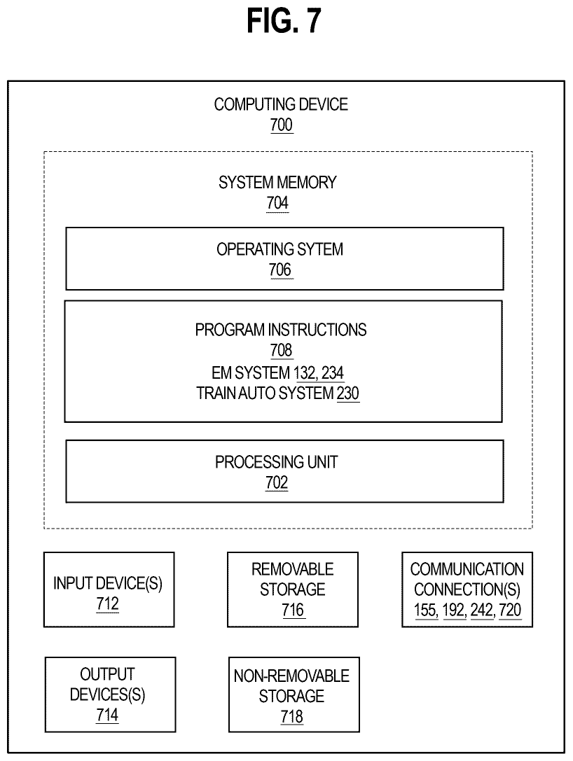

FIG. 7 is a block diagram illustrating physical components of an example computing device with which examples of the present disclosure may be practiced. The computing system 700 may include at least one processing unit 702 and the system memory 704. The system memory 704 may comprise, but is not limited to, volatile (e.g., random access memory (RAM)), non-volatile (e.g., read only memory (ROM)), flash memory, or any combination thereof. System memory 704 may include an operating system 706, one or more program instructions 708, and may include sufficient computer-executable instructions for operating the energy management systems 132, 234, 234-1, 234-2, the train automation system 230, as well as other systems described herein. Operating system 706, for example, may be suitable for controlling the operation of the computing system 700. Furthermore, examples may be practiced in conjunction with a graphics library, other operating systems, or other application programs and is not limited to any application or system. This basic configuration is illustrated by those components within a dashed line 710. The computing system 700 may also include one or more input device(s) 712 (e.g., keyboard, mouse, pen, touch input device, etc.) and one or more output device(s) 714 (e.g., display, speakers, printers, etc.).

The computing system 700 may also include additional data storage devices (removable or non-removable) such as, for example, magnetic discs, optical discs, or tape. Such additional storage is illustrated by removable storage 716 and a nonremovable storage 718. The computing system 700 may also contain a communication connection 720 that may allow the computing system 700 to communicate with other computing devices such as over a network in a distributed computing environment, for example, an intranet or the Internet. The communication connection 720 is an example of a communication medium, via which computer-readable transmission media (i.e., signals) may be propagated.

Program modules may include routines, programs, components, data structures, and other structures that may perform tasks or that may implement abstract data types. Moreover, examples may be practiced with other computer system configurations, including hand-held devices, multiprocessor systems, microprocessor-based or programmable user electronics, minicomputers, mainframe computers, and the like. Examples may also be practiced in distributed computing environments where tasks are performed by remote computing and processing devices that are linked through a communications network. In a distributed computing environment, programming modules may be in both local and remote memory storage devices. Furthermore, examples may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SOC)). Examples may also be practiced using other technologies capable of performing logical operations such as, for example, AND, OR, and NOT, including but not limited to mechanical, optical, fluidic, and quantum technologies. In addition, examples may be practiced within a general-purpose computer or in other circuits or systems.

Examples may be implemented as a computer process (method), a computing system, or as an article of manufacture, such as a computer program product or computer-readable storage medium. The computer program product may be a computer storage medium readable by a computer system and encoding a computer program with instructions for executing a computer process. Accordingly, hardware or software (including firmware, resident software, micro-code, etc.) may provide examples discussed herein. Examples may take the form of a computer program product on a computer-usable or computer-readable storage medium having computer-usable or computer-readable program code embodied in the medium for use by, or in connection with, an instruction execution system.

Examples of the present disclosure may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented within the computing system 700 or any other computing devices, in combination with the computing system 700, where functionality may be brought together over a network in a distributed computing environment, for example, an intranet or the Internet to perform the functions described herein. Systems, devices, and processors described herein are provided as examples; however, other systems, devices, and processors may comprise the memory storage and processing unit, consistent with the described disclosure.

### Industrial Applicability

According to examples of the present disclosure, systems and methods are provided for operating one or more locomotives of a train consist during times when communications to the one or more locomotives are lost depriving the locomotives of receiving real-time operating commands in an autonomous or semi-autonomous operating environment. According to examples, after a train consist is built with a number of rail cars and one or more locomotives required for powering the train consist, a remote or on board (i.e., on board a locomotive) energy management system receives operating data for the train consist including track and operating conditions, for example, track terrain, track curvature, track length, track signaling, track speed limits, locations of track stops, track crossings, and the like. In response, the energy management system generates real-time operating commands including throttle and brake settings for the train consist locomotives. The energy management system validates and refines the generated real-time operating commands using a machine learning system that may refine or modify the real-time operating commands based on machine learning analysis and pattern identification from a vast number of previously utilized real-time operating commands used in association with different track and operating conditions. The real-time operating commands are executed by a locomotive management system on each locomotive of the train consist. According to examples, the real-time operating commands are updated semi-continuously (e.g., every 2-5 seconds) based on ever-changing track and operating conditions.

Simultaneous with generation of the real-time operating commands, preplanned operating commands also are generated for the train consist locomotives that may be used to set throttling and braking settings for the locomotives during any time when communications to the lead train consist locomotive or between the lead train consist locomotive and remote or trailing train consist locomotives are lost. As with the real-time operating commands, the preplanned operating commands are generated by the energy management system in association with the machine learning system through which the preplanned operating commands may be refined or modified accordingly. The preplanned operating commands are used by the train consist locomotives when the energy management systems are not able to generate and update real-time operating commands owing to the loss of communications. For example, if it is known that the train consist will be travelling through a tunnel in which communications to the lead locomotive or between the lead locomotive and one or more remote or trailing locomotives may be lost, preplanned operating commands may be generated for operating the locomotives during the period of communications loss that takes into consideration the track and operating conditions that will be encountered during the period of communications loss. As with the real-time operating commands, the preplanned operating commands are updated semi-continuously so that, if they are executed during a period of communications loss, they most likely will be configured appropriately for down range track and operating conditions. After communications to the lead train consist locomotive or between the lead train consist locomotive and one or more remote or trailing locomotives are restored, the energy management systems automatically switch from the preplanned operating commands back to real-time operating commands.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

1. A method of controlling operation of a train consist, comprising:
generating one or more real-time operating commands for controlling operation of a train consist locomotive;
operating the train consist locomotive according to the one or more real-time operating commands;
generating one or more preplanned operating commands for controlling operation of the train consist locomotive during a period in which the one or more real-time operating commands are not available to the train consist locomotive;
receiving an indication that the one or more real-time operating commands are not available to the train consist locomotive; and
operating the train consist locomotive according to the one or more preplanned operating commands.

2. The method of claim 1, wherein:
prior to generating one or more real-time operating commands for controlling operation of a train consist locomotive, populating an energy management system with one or more track conditions;
generating the one or more real-time operating commands for controlling operation of a train consist locomotive based on the one or more track conditions; and
generating the one or more preplanned operating commands for controlling operation of the train consist locomotive based on the one or more track conditions.

3. The method of claim 2, wherein the one or more track conditions includes one or more of track terrain, track curvature, track length, track signaling, track speed limits, locations of track stops, and track crossings.

4. The method of claim 1, prior to operating the train consist locomotive according to the one or more preplanned operating commands, terminating operating the train consist locomotive according to the one or more real-time operating commands.

5. The method of claim 1, further comprising:
receiving an indication that the one or more real-time operating commands are available;
terminating operating the train consist locomotive according to the one or more preplanned operating commands; and
operating the train consist locomotive according to the one or more real-time operating commands.

6. The method of claim 1, wherein generating the one or more preplanned operating commands for controlling operation of the train consist locomotive during a period in which the one or more real-time operating commands are not available includes generating the one or more preplanned operating commands during a period in which a command communication to the train consist locomotive is terminated.

7. The method of claim 6, wherein receiving an indication that the one or more real-time operating commands are available includes receiving an indication that the command communication to the train consist locomotive is reestablished.

8. The method of claim 1, wherein operating the train consist locomotive according to the one or more real-time operating commands includes operating the train consist locomotive according to one or more real-time throttle and brake settings.

9. The method of claim 1, wherein operating the train consist locomotive according to the one or more preplanned operating commands includes operating the train consist locomotive according to one or more preplanned throttle and brake settings.

10. The method of claim 2, further comprising updating the one or more real-time operating commands for controlling operation of a train consist locomotive based on an update of the one or more track conditions.

11. The method of claim 2, further comprising updating one or more preplanned operating commands for controlling operation of the train consist locomotive based on an update of the one or more track conditions.

12. The method of claim 1, wherein generating one or more real-time operating commands for controlling operation of a train consist locomotive includes:
generating an initial one or more real-time operating commands for controlling operation of the train consist locomotive; and
passing the initial one or more real-time operating commands for controlling operation of the train consist locomotive to a machine learning system for refining the initial one or more real-time operating commands for controlling operation of the train consist locomotive.

13. The method of claim 1, wherein generating the one or more preplanned operating commands for controlling operation of the train consist locomotive includes:
generating an initial one or more preplanned operating commands for controlling operation of the train consist locomotive; and
passing the initial one or more preplanned operating commands for controlling operation of the train consist locomotive to a machine learning system for refining the initial one or more preplanned operating commands for controlling operation of the train consist locomotive.

14. A system for controlling operation of a train consist, comprising:
an energy management system operative;
to generate one or more real-time operating commands for controlling operation of a train consist locomotive; and
to generate one or more preplanned operating commands for controlling operation of the train consist locomotive during a period in which the one or more real-time operating commands are not available to the train consist locomotive;
a locomotive management system operative to operate the train consist locomotive according to the one or more real-time operating commands;
the energy management system being further operative to receive an indication that the one or more real-time operating commands are not available to the train consist locomotive; and
the locomotive management system being further operative
to operate the train consist locomotive according to the one or more preplanned operating commands.

15. The system of claim 14, wherein the energy management system is further operative:
to generate the one or more preplanned operating commands during a period in which a command communication to the train consist locomotive is terminated.

16. The system of claim 15, wherein the energy management system is further operative:
to receive an indication that the command communication to the train consist locomotive is reestablished and that the one or more real-time operating commands are available.

17. The system of claim 14, wherein the energy management system is further operative:
to generate an initial one or more real-time operating commands for controlling operation of the train consist locomotive; and
to pass the initial one or more real-time operating commands for controlling operation of the train consist locomotive to a machine learning system for refining the initial one or more real-time operating commands into the one or more real-time operating commands for controlling operation of the train consist locomotive.

18. The system of claim 14, wherein the energy management system is further operative:
to generate an initial one or more preplanned operating commands for controlling operation of the train consist locomotive; and
to pass the initial one or more preplanned operating commands for controlling operation of the train consist locomotive to a machine learning system for refining the initial one or more preplanned operating commands into the one or more preplanned operating commands for controlling operation of the train consist locomotive.

19. A method of controlling operation of a train consist, comprising:
populating an energy management system with one or more track conditions;
generating one or more real-time operating commands for controlling operation of a train consist locomotive;
operating the train consist locomotive according to the one or more real-time operating commands;
generating one or more preplanned operating commands for controlling operation of the train consist locomotive during a period in which the one or more real-time operating commands are not available to the train consist locomotive;
receiving an indication that the one or more real-time operating commands are not available to the train consist locomotive:
terminating operating the train consist locomotive according to the one or more real-time operating commands; and
operating the train consist locomotive according to the one or more preplanned operating commands.

20. The method of claim 19, further comprising:
receiving an indication that the one or more real-time operating commands are available;
terminating operating the train consist locomotive according to the one or more preplanned operating commands; and
operating the train consist locomotive according to the one or more real-time operating commands.
